(19) United States
(12) Patent Application Publication
(10) Pub. No.: US 2004/0255625 A1
(43) Pub. Date: Dec. 23, 2004

(54) System and method for securing all-terrain vehicles (ATVs) by securing the handle bar or steering arm to a solid structure on the vehicle

(76) Inventor: William E. Curl, Santa Clara, UT (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/817,724

(22) Filed: Apr. 2, 2004

Related U.S. Application Data
(60) Provisional application No. 60/460,675, filed on Apr. 4, 2003.

(51) Int. Cl. E05B 13/00

(52) U.S. Cl. 70/203

(57) ABSTRACT

A locking system and method for securing a vehicle, particularly, an all-terrain vehicle, by means of a hollow shaft engaged by a handle grip of the handle bar, which is connected to a tether that can be locked to a solid structure of the vehicle preventing the handlebar from further rotation and thereby disabling the vehicle's steering.

### RELATED APPLICATIONS

The present application claims priority under 35 U.S.C. § 119(e) from the following previously-filed Provisional Patent Application, U.S. Application No. 60/460,675, filed Apr. 4, 2003 by William E. Curl, entitled “A System and Method for Securing All-Terrain Vehicles (ATVs) by Securing the Handle Bar or Steering Arm to a Solid Structure on the Vehicle,” which is incorporated herein by reference in its entirety.

### BACKGROUND

All Terrain Vehicles or ATVs, during the early 1970's, were initially developed and used largely in Japan as a means of transportation between settlements in isolated, mountainous, or remote areas. ATVs were used under these circumstances because of their ability to navigate terrain that was not possible with other conventional modes of transportation. Since that time, ATVs have steadily increased in popularity in the United States filling similar roles.

In addition to their use as a necessary means of transportation, ATVs also can fulfill critical roles as utility vehicles. ATVs have proved to be vital tools in a wide variety of settings such as ranching, farming, industry, police-work, and mobility for disabled persons. Because ATVs perform essential roles such as these, it is extremely important for owners to protect against theft.

A more popular use for ATVs in the United States today is recreation. ATVs come in a wide variety of sizes and forms each tailored to perform in an equally wide variety of terrain and circumstances. They can be found operating in all seasons of the year and under almost all weather conditions. Because ATVs are likely to be operated in diverse settings for recreation, ATVs can often be vulnerable targets for theft from unsuspecting owners.

When not in use, ATVs typically require some form of short or long-term storage. ATVs often are manufactured with limited means for securing the vehicle against theft and thus require protective structures to house them. Such structures can often be impractical or too costly when storing ATVs, especially if the ATV is being used in remote wilderness areas. At the present time, there is a need for a better means of protecting ATV's against theft.

### SUMMARY

The present invention relates to the prevention of all-terrain vehicle (ATV) theft. More particularly, the present invention relates to a system and method for securing an ATV by incorporating a lock system that is applied to, for example, the steering arm or handlebar of the ATV.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a perspective view of the locking system placed on an all-terrain vehicle made with a front cargo rack according to one embodiment of the present invention.

FIG. 2 is a perspective view of the locking system according to an embodiment of the present invention as placed on an all-terrain vehicle that does not include a front cargo rack.

FIG. 3 shows a combination lock according to one embodiment of the present invention.

FIG. 4 shows a key lock according to one embodiment of the present invention.

FIG. 5 shows a padlock according to one embodiment of the present invention.

FIG. 6 is a flow chart describing one method of engaging the locking system placed on an all-terrain vehicle.

Throughout the drawings, identical reference numbers designate similar, but not necessarily identical, elements.

### DETAILED DESCRIPTION

In a variety of possible embodiments, the present invention provides a system for securing all-terrain vehicles. In one exemplary embodiment, such a system may include a hollow shaft that is applied to the handle grip of the handlebar of the ATV. The hollow shaft is connected to one end of a cable or other type of sturdy flexible link. A locking mechanism is further applied between the flexible link and a solid structure of the ATV preventing the handlebar from further rotation. As the handlebar is secured from rotating, the ATV is unable to be steered and thus is rendered inoperable to a thief.

Another embodiment of the present invention provides a method for making and using the system described above. Specifically, the present invention encompasses a method of securing an ATV for theft prevention comprising the use of applying a hollow shaft to the handle grip of the handlebar and engaging said shaft with a sturdy tether and locking mechanism. This method is performed by rotating the handlebar of the ATV in either direction to a desired position and placing the hollow shaft on the handle grip of the handlebar and then placing the lock and tether between the shaft and another solid structure of the ATV. Once the method has been performed, the handlebar cannot be further rotated, locking the steering mechanism of the ATV in one position. The vehicle is then rendered inoperable due to the inability to further steer the vehicle in any direction.

This specification provides a system and method for decreasing or eliminating the possibility of vehicle theft, particularly theft of all-terrain vehicles. A locking system is applied to a solid structure of the vehicle and a handle grip of the handlebar to disable the vehicle's steering and render the vehicle inoperable.

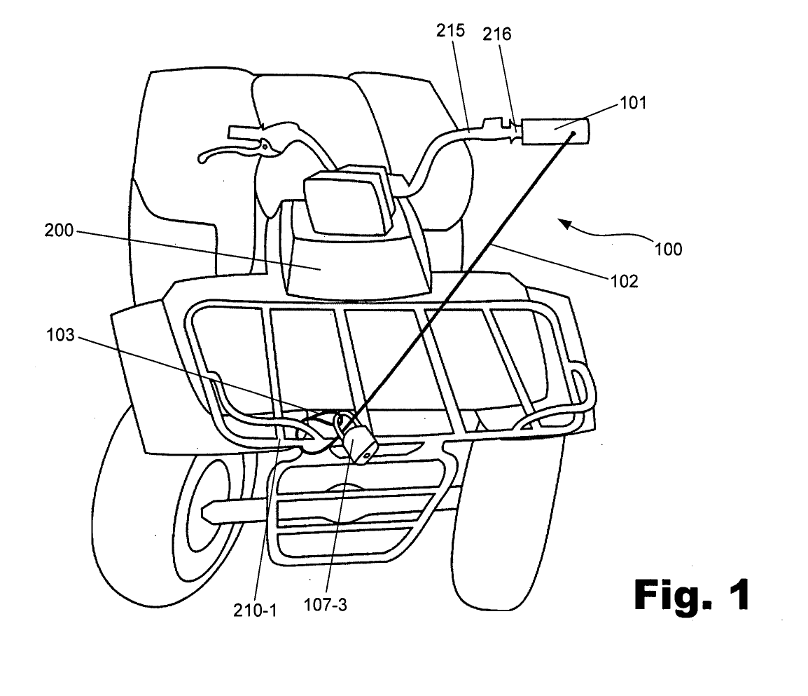

FIGS. 1-5 are depictions of several possible embodiments of the locking system (100). As shown in FIGS. 1-5 the locking system (100) consists of a hollow shaft (101) connected to a plastic coated metal cable (102). A loop (103) or segment is connected to, or formed at, one end of the cable (102) to secure the cable to a solid structure on the ATV. This loop (103) is created by bringing one end of the cable (102) in contact with a portion of the cable (102) and securing the two portions of the cable (102) with a clamping component.

A locking mechanism (107-1, 107-2, and 107-3) is incorporated in or used with the cable (102). The locking mechanism can be used to selectively secure the cable (102) to a solid structure on the ATV or to selectively make and close a break in the cable (102). Each part of the locking system as described above is preferably constructed of a material that resists corrosion and can withstand wear and tear in order to allow the locking system to resist tampering of any kind.

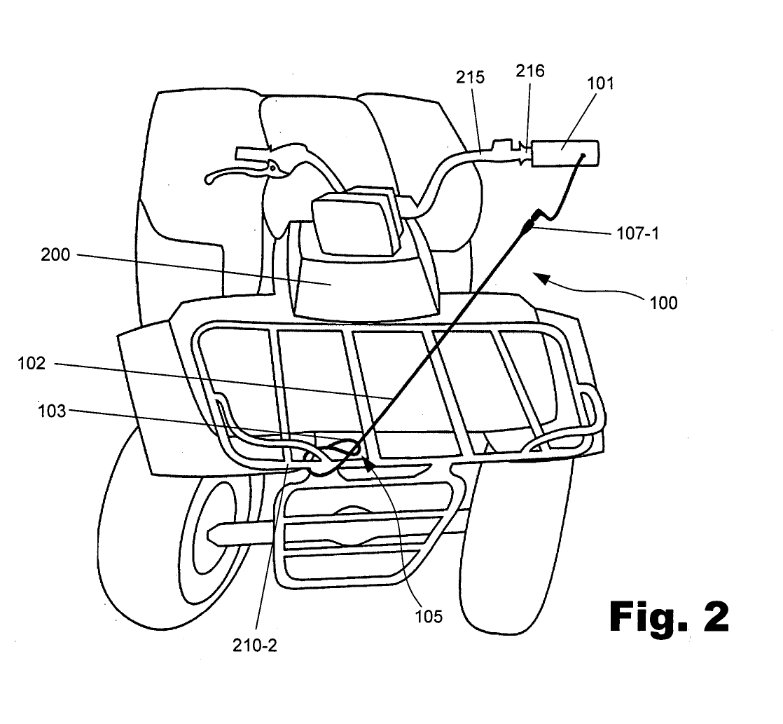

As shown in FIGS. 1-2 the hollow shaft (101) is constructed to receive a handle grip (216) of the handlebar (215). The hollow shaft (101) must be able to withstand environmental pressures that will result from human tampering, weathering, etc. Thus, in one of the possible embodiments, the hollow shaft (101) is made of plastic-coated metal. This would give the hollow shaft (101) the desired strength and durability necessary. An opening (101-1) on one end of the hollow shaft (101) is constructed to permit the hollow shaft (101) to slide over and enclose a handle grip (216). The size of the hollow shaft (101) is constructed to permit placement on a handle grip (216) while minimizing extra space that would allow the hollow shaft (101) to be loose fitting on the handle grip (216).

The loop (103) at the end of the cable (102) is used to engage a solid structure (210-1-210-2) of the vehicle (200) shown in FIGS. 1-2. The loop also can be, for example, used to form a noose (105), shown in FIG. 2, with the cable (102) itself. The noose is formed so as to enclose and cinch down upon a solid structure (210-1-210-2) of the vehicle (200).

The locking mechanism (107-1, 107-2, and 107-3) shown in FIGS. 1-5 is used to lock the cable (102) in place so that there is tension in the cable (102). As shown in FIGS. 1-2, when the locking mechanism is locked as described, the hollow shaft (101) and the cable (102) will tightly engage the handle grip (216) and a solid structure (210-1-210-2) of the vehicle (200), respectively, such that locking system cannot be removed from the vehicle (200) and will not allow the handlebar (215) to further rotate.

The all-terrain vehicle (200) depicted in FIGS. 1-2 cannot be steered without free movement of the handlebar (215). Consequently, by having the locking system (100) in place to prevent rotation of the handlebar (215), the vehicle (200) cannot be operated by possible thieves.

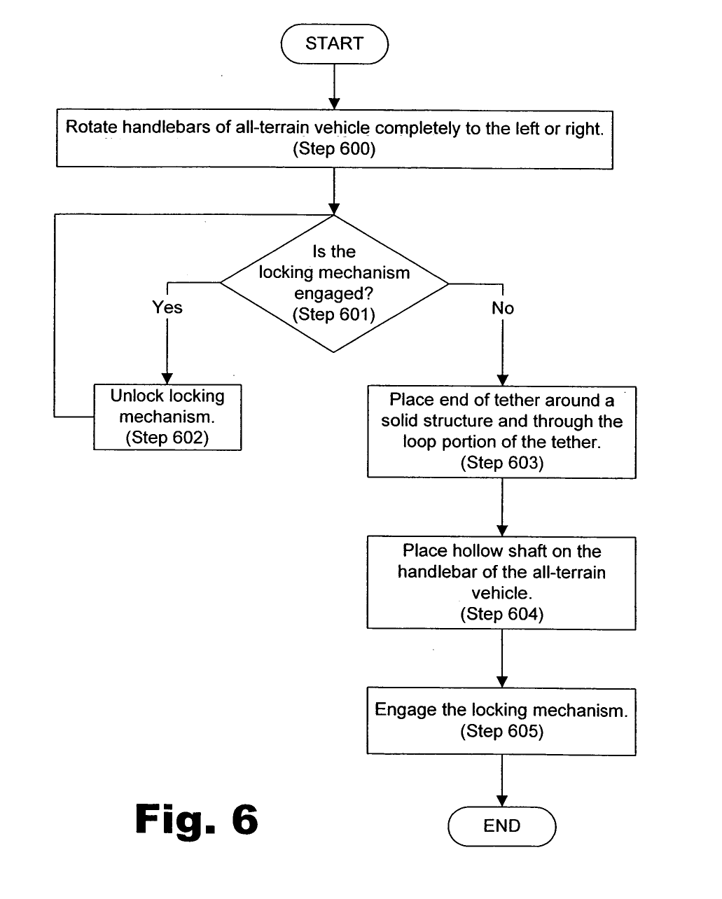

The method by which the locking system (101) is affixed to the all-terrain vehicle (200) is depicted in FIG. 6. This method is as follows:

First, the handlebar (215) shown in FIGS. 1-2 of the all-terrain vehicle (200) may be rotated to a desired position in which the steering of the vehicle (200) will be locked (Step 600). This position preferably is when the handlebar (215) is turned completely to one side or the other until the stop block inhibits any further turning and the vehicle (200) can only travel in a tight circle.

Next, the locking mechanism (107-1, 107-2, and 107-3) illustrated in FIGS. 1-5 is disengaged (if engaged) (Steps 601 and 602). In this state a noose (105) may be formed (if not previously formed) with a portion of the cable (102) and the loop (103) (Step 603). The noose (105) may be formed while encircling a solid structure (210-1-210-2) of the vehicle (200) as illustrated in FIGS. 1-2 or by placing the noose (105) on a solid structure (210-1-210-2) once formed. Where applicable, the loop (103) itself may be used to engage a solid structure (210-1-210-2) of the vehicle (200) as apposed to forming a noose (105). The solid structure (210-1-210-2) is preferable located near the front of the vehicle (200) and in close proximity to the side opposing the side that the handle grip (216) is located on.

Next, the hollow shaft (101) is placed on a handle grip (216) (Step 604). The hollow shaft (101) is preferably sized and shaped such that once it is forced over the handle grip (216) it cannot be removed without an extraordinary amount of force. The harder the hollow shaft (101) is to remove, the more secure the system is. The handle grip (216) to which the hollow shaft (101) is applied is preferably the one forced furthest toward the front of the vehicle (200) when rotating the handlebar as shown in FIGS. 1-2.

Finally, when both the cable (102) and the hollow shaft (101) are engaged as described, the locking mechanism (107-1-107-3) is applied to prevent further movement of the locking system (100) (Step 605). When the locking system (100) is appropriately configured on the vehicle (200) as depicted in FIGS. 1-2, there is tension in the cable (102), which prevents the cable (102) from disengaging the solid structure (210-1-210-2) and the hollow shaft (101) from disengaging the handle grip (216). The locking system (100) applied as described will prevent the handlebar (215) from further rotation. If the vehicle (200) is operated in this arrangement the vehicle (200) can only move in a circle consistent with the locked position of the handlebar (215).

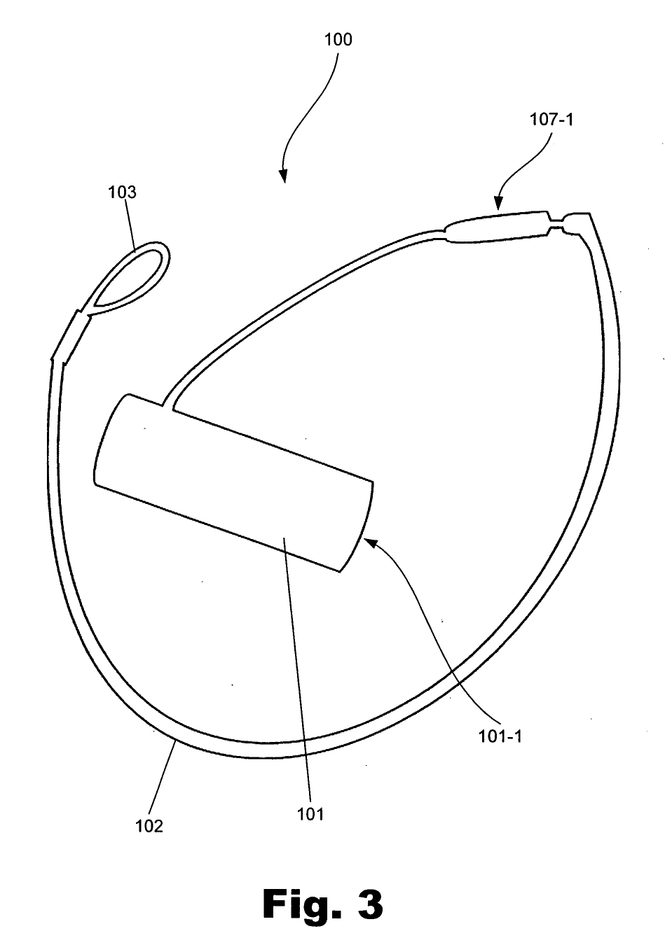

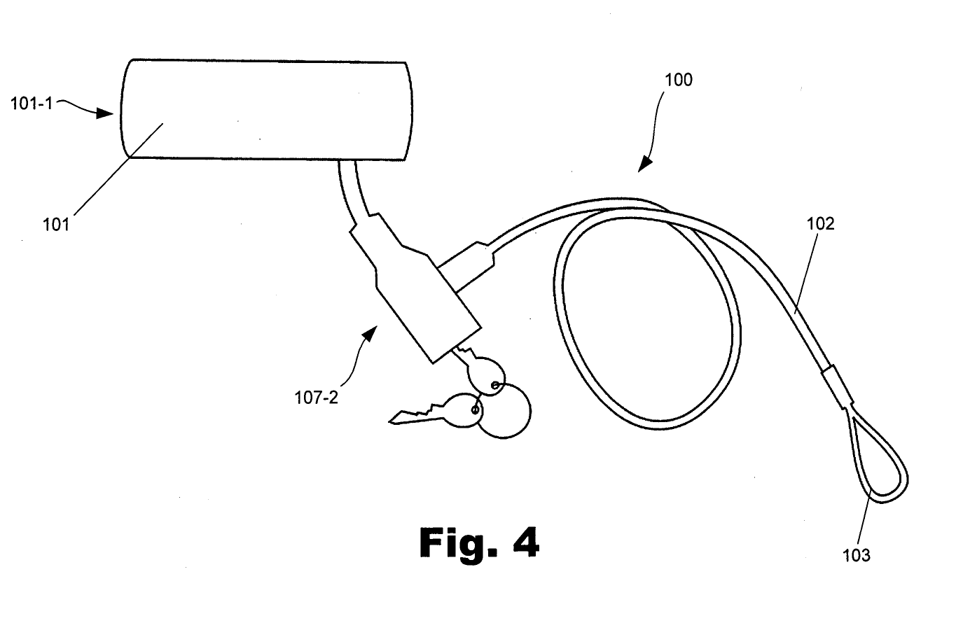

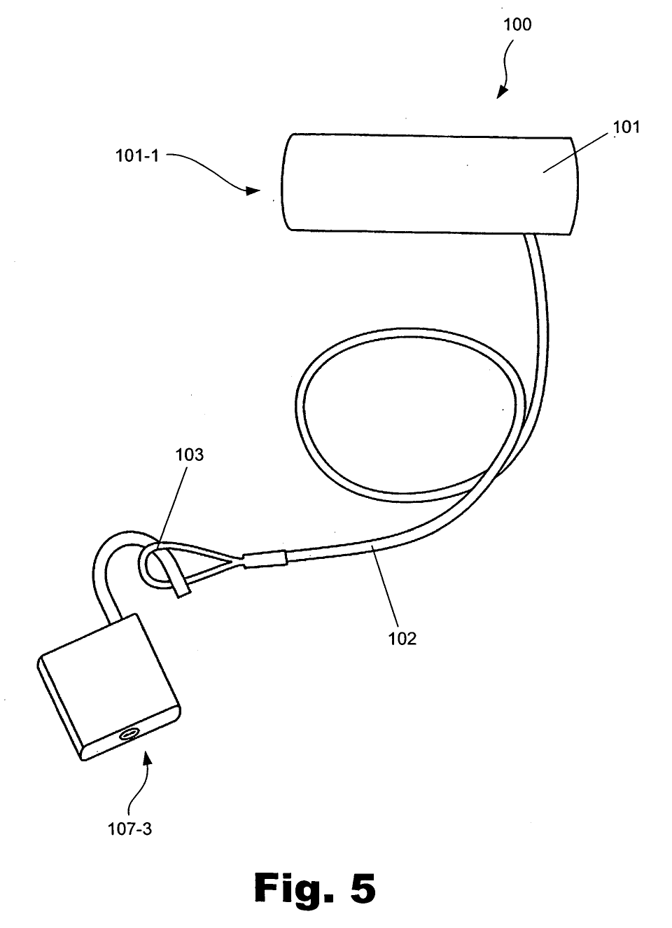

FIGS. 1 and 5 illustrate the locking system (100) configured such that the locking mechanism is a padlock (107-3). FIGS. 2 and 4 illustrate the locking system (100) configured such that the locking mechanism is a key lock (107-2). FIG. 3 illustrates the locking system (100) configured such that the locking mechanism is a combination lock (107-1).

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. An all-terrain vehicle anti-theft lock system comprising:
a hollow shaft sized to receive a handle grip of a handlebar of said all-terrain vehicle;
a tether constructed on one end to be engaged by a solid structure of said all-terrain vehicle and connected on another end to said hollow shaft;
a locking mechanism on said tether for selectively securing said tether to said solid structure of said all-terrain vehicle or selectively releasing or sealing a break in said tether.

2. The system of claim 1, wherein said all-terrain vehicle is a watercraft.

3. The system of claim 1, wherein said all-terrain vehicle is a snow-machine.

4. The system of claim 1, wherein said all-terrain vehicle is a two, three, four, or six wheeled vehicle.

5. The system of claim 1, wherein said hollow shaft is proportional in length to said handle grip of said handlebar.

6. The system of claim 5, wherein said hollow shaft is made of a material or materials to prevent destruction and extreme wear and tear of said hollow shaft.

7. The system of claim 1, wherein said solid structure of said all-terrain vehicle is located on the lower front side, said side being the opposing side of said handle grip of said handlebar.

8. The system of claim 1, wherein said solid structure of said all-terrain vehicle is the front utility rack of said all-terrain vehicle

9. The system of claim 6, wherein said tether is proportional in length to the shortest distance between said solid structure and said handle grip.

10. The system of claim 1, wherein said tether is plastic coated steel cable.

11. The system of claim 9, wherein said end of said tether constructed to be engaged by said solid structure of said all-terrain vehicle is a loop.

12. The system of claim 1, wherein said tether is a linked steel chain.

13. The system of claim 1, wherein said locking mechanism is a separable padlock.

14. The system of claim 1, wherein said locking mechanism is a combination lock.

15. The system of claim 1, wherein said locking mechanism is a key lock.

16. A method of securing an all-terrain vehicle from theft, said method comprising physically preventing rotation of a handlebar of said all-terrain vehicle with a locking system secured between said handlebar and a solid structure of said all-terrain vehicle.

17. The method of claim 16, further comprising locking said locking system between said handlebar and a solid structure of said all-terrain vehicle.

18. The method of claim 17, further comprising a hollow shaft on said locking system, said method comprising engaging said hollow shaft to a handle grip of said handlebar.

19. The method of claim 18, further comprising a tether secured to said hollow shaft, said method comprising engaging said tether with said solid structure of said all-terrain vehicle.

20. The method of claim 19, further comprising locking said hollow shaft and said tether into a relative position when engaging said tether and said solid structure of said all-terrain vehicle.
